(19) United States
(12) Patent Application Publication
(10) Pub. No.: US 2002/0175894 A1
(43) Pub. Date: Nov. 28, 2002

(54) Hand-supported mouse for computer input

(76) Inventor: Vince Grillo, Boise, ID (US)

Correspondence Address: PEDERSEN & COMPANY, PLLC, P.O. BOX 2666, BOISE, ID, 83701, US

(21) Appl. No.: 10/094,594

(22) Filed: Mar. 6, 2002

Related U.S. Application Data
(60) Provisional application No. 60/273,958, filed on Mar. 6, 2001.

(51) Int. Cl. G09G 5/00

(52) U.S. Cl. 345/156

(57) ABSTRACT

This invention is a mouse for positioning a cursor on the screen of a computer monitor and for inputting computer program instructions. The mouse is conveniently held in the palm of the user's hand. The mouse has a relatively thin and flat body portion, preferably less than about ½″ thick at its widest point, for being received in the palm of the user's hand. The mouse body has buttons for performing normal mouse functions. The mouse also has a head portion which is at least as large as the body portion, for extending out of the palm of the hand of the user. The head portion is adapted to provide a track ball or other cursor positioning switch, as well as a scroll or a click function. All mouse actions, i.e., track ball, buttons and so forth, can be accomplished without removing the user's hand from the keyboard. The mouse body also has a strap for securing the body to the user's hand, a means for sensing and processing the track ball, buttons, and other actions, a means for transmitting the mouse actions to the computer, and a means for supplying power to the mouse. In alternative embodiments, a scroll wheel is provided, and an option for cordless operation is available.

### BACKGROUND OF THE INVENTION

This application claims priority of our prior, co-pending provisional patent application, Serial 60/273,958, filed on Mar. 6, 2001, entitled “Hand-Supported Mouse for Computer Input,” which is incorporated herein by reference.

### FIELD OF THE INVENTION

This invention relates generally to pointing devices for computer screens. More particularly, this invention relates to a mouse adapted to be supported by a strap around the back of a user's hand, and positioned in the palm of the user's hand while it is operated.

### RELATED ART

A mouse is fundamental to the operation of nearly all personal computer programs. A mouse is used to move a cursor to a specific location on the monitor screen and to control a myriad of other program operations. Conventional mouses include at a minimum, a surface for the operator's hand to grasp the mouse, a ball that when rotated moves the cursor around the screen and a plurality of switches (i.e., buttons) by which other computer functions may be controlled. Additionally all mouses must have a power source, the necessary sensing and processing circuitry and a signal transmission means such that mouse operations may be communicated to the computer and its display screen.

Generally mouses incorporate one of two forms of cursor positioning balls. The most common has a ball positioned in the bottom of the mouse where it may be rolled on a flat surface, often a special mouse pad. Alternatively, a “track” ball is set in a socket on an upper surface of the mouse and rotated by the operator's thumb or fingers. The switches/buttons on mouses are of the “momentary on” type and are most frequently positioned for operation by the operator's index and middle fingers. These buttons control various program functions such as “left click”, “right click”, “double click”, “drag and drop”, “click and drag” and “scroll”. On many mouses, these or other buttons are programmable so that the user may assign specific program functions to individual buttons. The “scroll” function is in most cases provided by a small, finger actuated wheel that when rotated causes the display on the screen to move up or down depending on the direction the wheel is rotated.

Developers of portable computers such as laptops and notebooks have integrated mouse functions into the computer so that a separate mouse is not required. These pointing devices include a miniature track ball or a “joy stick” mounted between the keys or a small drawing slate, usually directly in front of keyboard. The mouse is moved by rotating the track ball, pressing the joy stick in the direction one wishes to move the cursor or by moving one's finger around the drawing slate (the cursor follows the movement of the finger). Additional keys or buttons are provided for the various mouse “click” functions. Because many users find these mouse substitutes difficult to use, nearly all portable computers provide for the external connection of a conventional mouse.

In using a personal computer, the vast majority of the user's input is produced by finger strokes acting on the keys of a keyboard, i.e., typing. However, a significant portion of the input must also come from a mouse. Thus, the major input function, i.e., typing, must be interrupted by moving one's hand from the keyboard to the location of the mouse. This movement to and from the mouse location often requires a hand and forearm movement of more than one foot in each direction. Many computer users complain of the awkwardness of this movement and frequent discomfort in using the mouse. In addition to the wasted time and motion in using conventional mouses, they require significant desktop work space. With ever increasing demand for equipment on the desktop, e.g., monitors, printers, scanners, telephones and fax machines, desktop real estate is becoming a scarce commodity.

To reduce the inconvenience and discomfort in using mouses, many new developments in their configuration and functions have appeared. For example, the shape of the mouse, the location of the buttons, and even the track ball have received a substantial amount of attention. A major advancement was the development of the cordless mouse, a mouse that communicates with the computer via a radio frequency, infrared or optical link. This feature allows the user to have greater flexibility in locating the mouse in relation to the user's keyboard, work surface and seating location.

Clearly there remains a strong need to provide a robust and practical device that permits the user to perform all mouse functions without removing his/her fingers and hands away from the keys and the keyboard. A mouse device that can be conveniently and comfortably held in one of the computer user's hands is needed. This needed device must be designed and positioned such that, when the mouse is in the computer users hands, the user's fingers do not have to be moved away from their “home” position on the keyboard.

Inventors have disclosed hand-held devices for controlling machines and inputting data to personal computers. The following reviews the few disclosures known to be relevant to the extant invention.

Cartabiano et al. (U.S. Pat. No. 5,764,164) disclose an ergonomic hand-attachable controller that is mounted in the palm of a user's hand and has attachments for further connecting the device to the user's forearm. The device further includes a base having a plurality of keys or switch buttons. This base extends forward under the operator's hand such that the buttons are placed conveniently for access by the user's fingers. This device would not be suitable as a personal computer mouse since it encumbers the hand such that normal keyboard typing could not be performed.

George (U.S. Pat. No. 5,267,181) teaches a “cybernetic interface” for a computer that uses a hand held “chord” keyboard. A chord keyboard usually has from 5 to 25 keys and is a replacement for the conventional QWERTY keyboard. Characters are generated with this device by pressing one or more keys simultaneously. It is alleged that a chord keyboard is quicker to learn than the conventional QWERTY keyboard. This chord keyboard has an ergonomically designed handle that has an integral chord keyboard. Although this device is handheld, it is a replacement for the conventional keyboard and thus does not address the issues as described herein.

Hilbrink, et al. (U.S. Pat. No. 5,754,126) teaches a wireless “pointing device” which fits in the palm of a user's hand. This palm mouse includes a first portion having a ball for generating pointing signals, the ball being placed in an aperture of a bottom surface, a control circuit for processing the pointing signals and an ovoid-shaped top surface. A second portion includes a J-shaped flexible member that is attached to the first portion. Transmitting and receiving antennas, a power supply, and receivers are also included. When using Hilbrink's device, the ovoid-shaped surface is placed in the palm of the user's hand and is held in place by the J-shaped member passing between the thumb and first finger and over the top of the user's hand.

Although Hilbrink's objective was to provide mouse functions without moving the hand away from the keyboard, the placement of the ball is such that the ball could easily be inadvertently rotated by contact with the keyboard surfaces. Thus unwanted cursor movements could occur while one is typing. In addition, Hilbrink's device is not securely held within the hand and normal typing motions are likely to require the user to frequently use the other hand to reposition the J-shaped member. This movement seemingly requires that the user's hand be substantially lifted above the keyboard thus likely causing the operator to lose his/her home location on the keyboard.

Butler, in (U.S. Pat. No. 6,154,199), discloses a hand-positioned mouse that is an article such as a glove or half glove that is worn on the hand of a computer user. In this invention a tracking ball is attached to the side of the first finger of the glove such that it can be operated by the thumb. Switching functions are positioned on the palm of the glove such that they may be operated by a finger. Mouse generated signals are transmitted to the computer via a conventional electrical cable or they may be communicated by a radio frequency link. Butler's invention encumbers the computer user with a potentially uncomfortable glove that is likely to be difficult to remove (and to later put back on) to perform the numerous other activities that one typically encounters in an office setting (for example signing documents, greeting people, handling papers, using the telephone, etc.). Also, a variety of glove sizes would need to be available to fit the various users.

As can be seen from the above review, significant opportunities remain to provide a mouse that can be comfortably and efficiently used without removing one's fingers far from their home position, or moving one's hands from the keyboard, or encumbering mouse functions or other office related activities.

Thus it is a primary object of this invention to provide a computer mouse that can be held in the palm of a computer operator's hand so that the hand does not have to be moved away from the keyboard to access the mouse. It is a second object of this invention to provide a mouse that can be operated with the user's hands remaining at the home position on the keyboard. It is another object of this invention to provide a mouse with a conventional track ball, a plurality of conventional mouse buttons, and a scroll wheel. Another object of this invention is to operate the mouse in either a corded or cordless fashion. It is another object of this invention to provide a mouse that requires no desk space for its use. It is another object of this invention to provide a mouse that will decrease the stress and strain on the computer user's hands, wrist, arms, neck and back. It is yet another object of this invention that the features of this invention may be used to control machinery, robots, computer games, and the like.

### SUMMARY OF THE INVENTION

This invention is a mouse for positioning a cursor on the screen of a computer monitor and for inputting computer program instructions. The mouse is conveniently supported by a strap around the back of the computer user's hand so that the mouse is conveniently held in the palm of the user's hand. All mouse actions, i.e., track ball, buttons and so forth, can be accomplished by this mouse without removing the user's hand which supports the mouse from the keyboard. The buttons provide the “clicking” functions common to conventional computer mouses, e.g., left click, right click, drag and drop, etc.

This novel mouse comprises a mouse body supported by the user's hand and positioned in the palm of the user's hand, a track ball rotatably supported within the mouse body, at least one, and preferably a plurality of buttons on the mouse body, a strap connected to the mouse for passing around the back of the hand for securing the mouse to the user's hand, a means for sensing and processing the track ball, buttons and other actions, a means for transmitting the mouse actions to the computer, and a means for supplying power to the mouse.

In this ergonomically designed invention, the track ball is placed on a head portion of the mouse extending out from the palm of the hand to become conveniently immediately adjacent to the pad of the user's thumb. Similarly the mouse buttons are placed conveniently to become within easy reach of the user's fingertips. Therefore, with this invention, all mouse actions may be accomplished without moving the user's hands from the “home” typing position at the keyboard.

Preferably, the body of the mouse is ergonomically formed from a compliant and resilient material such that it may be squeezed by the hand of the operator be comfortable, and to enable to exercise of his/her hand to relieve muscle strain, repetitive stress syndrome and generally relieve some of the physical tedium of keyboard data entry. Additionally, the body of the mouse may be made of a resilient material with “memory,” so that its overall shape may be adjusted by bending or squeezing to become a custom fit with the user's hand.

The body of the mouse of this invention is slender, or thin, so that it conveniently fits into the palm of the user's hand without interfering with the user's ability to operate the computer keyboard keys. Preferably, the mouse is less than about ½ inch thick at its widest point. Also, the body of the mouse of this invention is arranged like a pistol grip in that the sides are relatively flat and almost parallel. There may be some taper in the shape of the mouse from the front (distal) edge to the rear (proximal) edge, and some rounding of the font and back edges for grip comfort. Preferably, however, the mouse of this invention is thin and flat.

Also, the mouse of this invention has a head portion which is adapted to extend out of the palm of the hand of the user when the body portion is in the palm of the hand. The head portion of the mouse of this invention is as large, and preferably is larger in dimension than, the body portion. This way, multiple capabilities of the mouse of this invention may be placed in the head portion for operation by the thumb of the user. For example, a track ball or 4-way positioning switch may be placed in the head portion, along with a scroll function or a click function.

In alternative embodiments, a scroll wheel and cordless operation are provided.

These and many other features and attendant advantages of the invention will become apparent as the invention becomes better understood by reference to the following detailed descriptions and accompanying drawings.

### BRIEF DESCRIPTION OF THE DRAWINGS

FIG. 1 is a front perspective view of a first embodiment of this invention in the palm of the user's hand.

FIG. 2 is a rear perspective view of a first embodiment of this invention showing the back of the user's hand.

FIG. 3 is a rear perspective view showing an alternative means for securing the mouse body to the user's hand.

FIG. 4 is a front perspective view of a second embodiment of this invention incorporating a scroll wheel and cordless operation.

FIGS. 5-7 are perspective views of additional, alternative embodiments of this invention.

### DESCRIPTION OF THE PREFERRED EMBODIMENTS

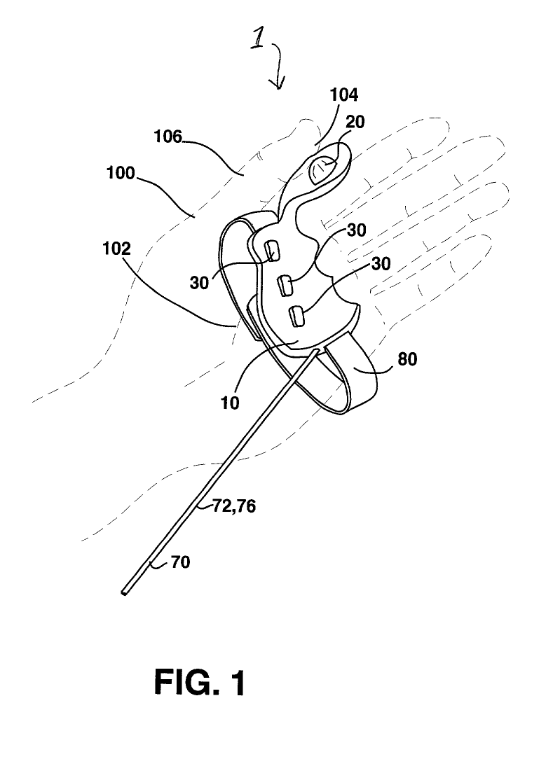

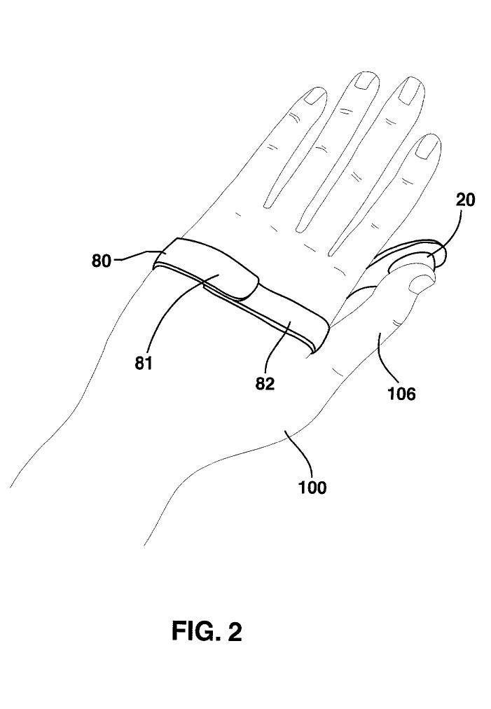

As shown in FIGS. 1 and 2, a first embodiment of this invention, a palm mouse 1, comprises mouse body 10 positioned in palm 102 of user's hand 100, track ball 20 rotatably supported within the mouse body, a plurality of buttons 30 on the mouse body, strap 80 for securing the mouse body to the user's hand, a means for sensing and processing the track ball and buttons actions (not shown), a means for transmitting 72 the track ball and buttons actions to the computer, and a means for supplying power 76 to the mouse. In this first embodiment, the means for transmitting and the means for supplying power are provided by a conventional electrical connecting cable 70.

It is anticipated that electrical connecting cable 70 will preferably have a rigid section extending from body 10 alongside or perpendicular to the user's wrist and forearm such that the cable will not interfere with keyboard operations.

Buttons 30 perform the normal mouse operations of “left click”, “right click”, “drag and drop”, etc. It is also anticipated that at least one of the buttons may be programmable such that the user can define its function. Any number of buttons is allowable, however most commonly two buttons will be provided, one each for the “left click” and the “right click” functions.

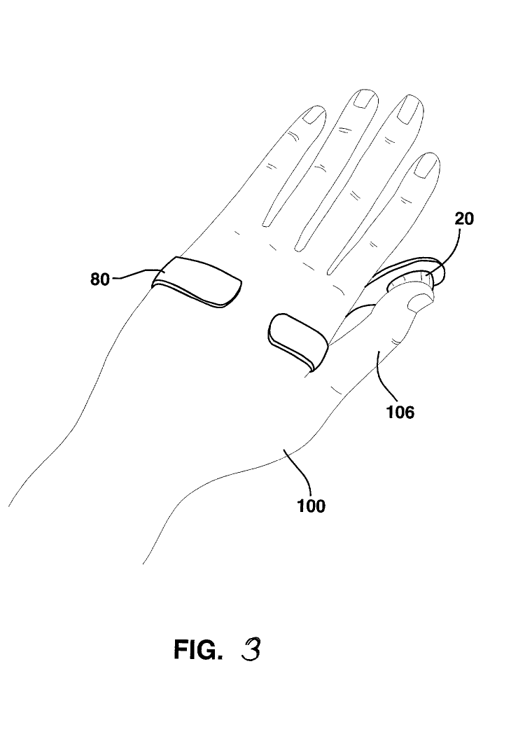

With reference to FIG. 2, strap means 80 is formed from two sections 81, 82 of flexible strap material. One proximal end of each strap section is secured to mouse body 10. As shown in FIG. 2, the other, distal ends have cooperating hook and loop fasteners for removably connecting the strap sections at the back of the user′ hand. Alternative fasteners such as buckles, snaps and so forth are acceptable. Or strap 08 may be in one, adjustable piece, or an elastic piece. A bracelet arrangement for as shown in FIG. 3 is also acceptable. In this case, the bracelet material would need to be sufficiently firm to maintain the mouse in its proper location in the palm of the user's hand.

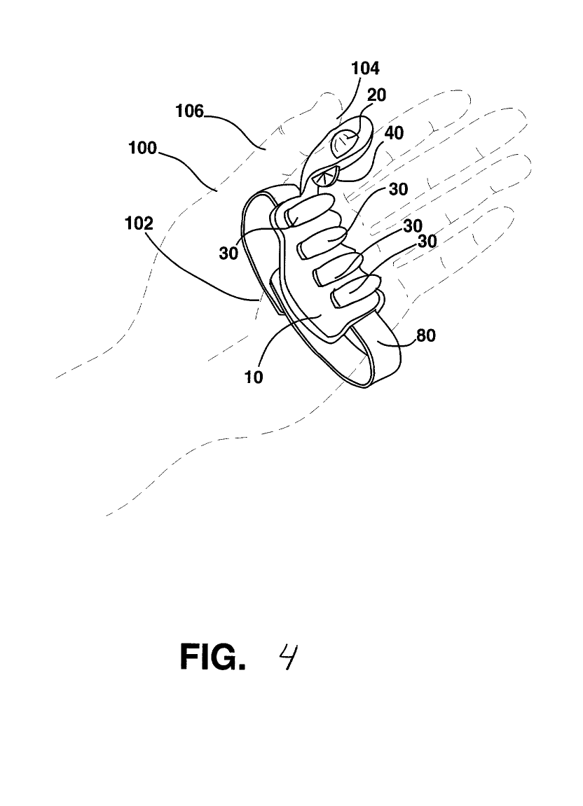

FIG. 4 shows a second embodiment of the present that incorporates scroll wheel 40 into mouse body 10. FIG. 4 also depicts the cordless method of providing the means for transmitting the mouse actions to the computer. Replaceable batteries (not shown) in body 10 are the means for supplying power in this cordless configuration.

Known cordless signal transmission technology is used in the cordless embodiment. Also, it is anticipated that in the cordless embodiment, a mouse motion sensing circuit may be incorporated to provide an automatic power on/power off capability so that an external conventional on/off switch will not be required to conserve battery power when the mouse is not being used. The battery power supply can use conventional disposable batteries or rechargeable batteries. In the later case, a charging cradle (not shown) would be used to place the mouse in when it is not being used.

In all embodiments, known technology is used for the means for sensing and processing the motions of track ball 20, buttons 30 and scroll wheel 40.

In this ergonomically designed invention, for example, as depicted in FIG. 4, track ball 20 and scroll wheel 40 (when included) are placed conveniently immediately adjacent to pad 104 of user's thumb 106. The track ball and scroll wheel are positioned such that thumb 106 may conveniently and quickly access either the scroll wheel or the track ball. Similarly mouse buttons 30 are preferably placed conveniently within easy reach of the user's fingertips. It is also acceptable to place the scroll wheel such that it may be operated by one of the user's fingers instead of the thumb. In all configurations however, it is essential that all palm mouse functions be easily accessed and actuated without moving the user's hands from the keyboard area.

The FIGS. 1-4 accompanying this discussion show only left-hand configurations of this invention. It is anticipated that mirror image, but otherwise identical, right-hand configurations will also be produced.

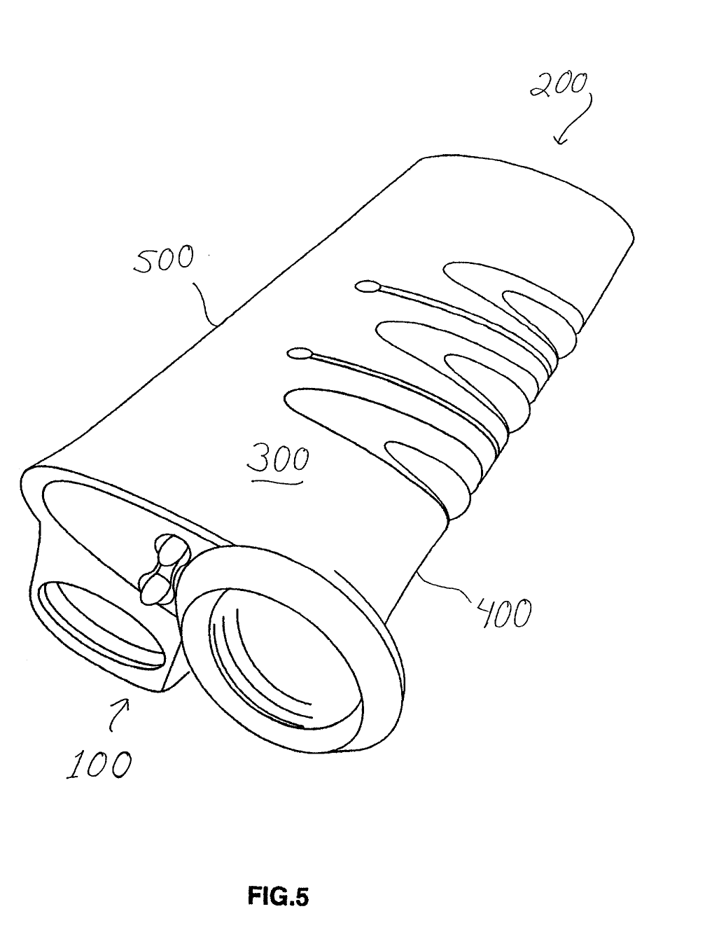

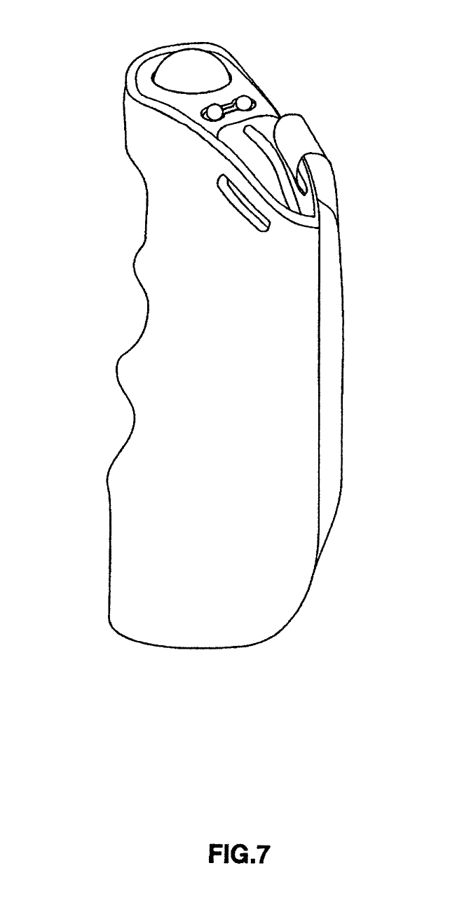

The FIGS. 5-7 show alternate right hand embodiments of this invention. These Figures help indicate that the present invention may be presented in any one or more of the many, many possible embodiments. Always, however, the mouse of this invention is adapted to be operated while being held near the palm of the user's hand, and supported there by the strap means across the back of the hand.

Always, also, the mouse of this invention has a relatively thin and flat body portion for being comfortably received in the palm of the hand of a user, without interfering with the user's ability to operate the keys of the computer keyboard while the mouse is in the hand. Preferably, the mouse is less than out ½ thick at its widest point. Also, the body of the mouse of this invention has a head portion which is adapted to extend out of the palm of the hand of the user. The head portion is preferably larger in size than the body of the mouse. This way, the head portion may provide for a plurality of capabilities to be operated by the thumb. For example, the head portion may be large enough to have a track ball or 4-way positioning switch, as well as an additional scroll function or a click function.

Yet another important feature of this invention is that body 10 of palm mouse 1 is formed from a thin, compliant and resilient material, such as polyurethane. Thus, the palm mouse of this invention may be squeezed by the computer operator to exercise his/her hand and thus relieve strain and stress to the hand, wrist, forearm, elbow and shoulder, etc. Additionally, the body of the mouse may be made of a resilient material with “memory”, so that its overall shape may be adjusted by bending or squeezing to become a custom-fit with the user's hand. Also, the body of the palm mouse could contain small, light weight permanent magnets to provide magnetic therapy to the user's hand. Track ball 20, buttons 30 and scroll wheel 40 may all be formed using conventional methods and materials.

Many detailed features may be included in embodiments of the present invention. For example, the electronic components may be adapted to be fitted into a thin, box-like package that slips into an open end of the mouse, and cooperates with the thumb and finger controls on the mouse which interface and fit with corresponding switches on the box-like package. This way, the box-like control package may be conveniently mass-manufactured, and then conveniently slipped into one of many cooperating shells like those depicted in FIGS. 1-7. Also this way, the same control package may be conveniently slipped into different shells for right or left hand, for example, or for large and small hands, for example.

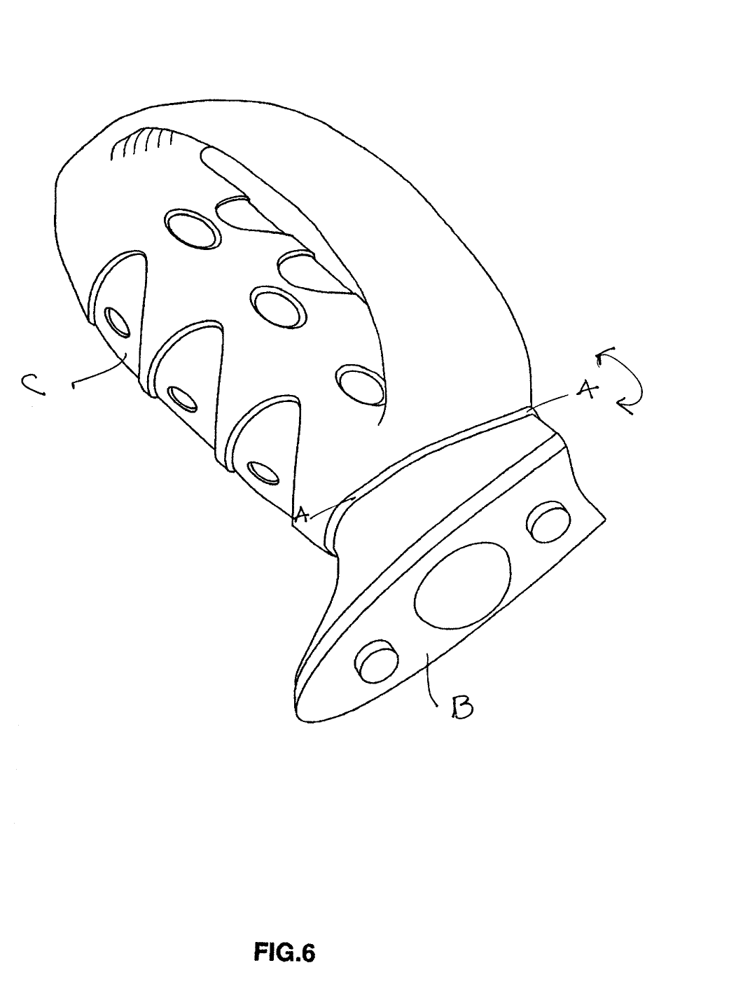

Also, sections of the outer surfaces of the mouse of this invention may be moveable, relative to other sections. For example, the seam line A-A depicted in FIG. 6 may be for a selectively pivotal relationship between the head B and the body C of the embodiment of the present invention as depicted by the arrow for movement therein. This way, the angle of the head B and distance of the head B from the body C may be selectively adjusted by the user for individual comfort and productivity.

Referring to FIG. 5, Here are Some Definitional Terms

1. The top of the mouse is at 100;

2. The bottom of the mouse is at 200;

3. A side surface of the mouse is at 300;

4. The distal edge is at 400; and

5. The proximal edge is at 500.

By “flat,” I mean not bulbous, and if curved, curved only slightly.

It is also anticipated that known gyroscopic technology may be incorporated into the palm mouse. By doing so, the screen cursor can be controlled by slight movements of the user's wrist while it rests at the base of the keyboard thus maintaining the operator's home position, ready for typing. In addition it is expected that the features and functions of this invention may be incorporated into controls for machinery, robots, computer games, and the like. In such applications, by incorporation of gyroscopic technology, machine, screen cursor and game controls can be accomplished by merely moving one's hand in space. The track ball, buttons and scroll wheel, then, would provide additional control functions.

Although this invention has been described above with reference to particular means, materials and embodiments, it is to be understood that the invention is not limited to these disclosed particulars, but extends instead to all equivalents within the scope of this description, drawings and the following claims.

I claim:

1. A hand-supported mouse for computer input; comprising:
a thin and flat body portion for being comfortably received in the palm of a hand of a user;
the body portion having a surface for cooperating with the fingers of the hand of the user, the surface having at least one button for performing normal mouse operations;
a head portion for extending out from the palm of the hand of the user when the body portion is in the hand of the user, the head portion being at least as large as the body portion; and
a strap connected to the mouse for extending around the back of the hand of the user and securing the mouse to the hand.

2. The hand-supported mouse of claim 1 wherein the head portion has a cursor position capability and a scroll capability.

3. The hand-supported mouse of claim 1 wherein the head portion has a cursor position capability and a click button capability.

4. The hand-supported mouse of claim 1 wherein the body portion is about ½ inch thick at its widest point.

5. The hand-supported mouse of claim 1 wherein the sides of the body portion are approximately parallel.
